(19) United States
(12) Patent Application Publication
(10) Pub. No.: US 2005/0190414 A1
(43) Pub. Date: Sep. 1, 2005

(54) Photographic film scanner with variable exposure settings

(76) Inventors: Darren Dru Walde, Arlington, VA (US); Marc E. Zapf, Aldie, VA (US); Alexander Sokolskiy, East Longmeadow, MA (US)

Correspondence Address: Charles B. Lobsenz;Roberts, Mlotkowski & Hobbes, PC, Suite 850, 8270 Greensboro Drive, McLean, VA, 22102, US

(21) Appl. No.: 11/054,857

(22) Filed: Feb. 10, 2005

Related U.S. Application Data
(60) Provisional application No. 60/543,646, filed on Feb. 11, 2004.

(51) Int. Cl. H04N 1/04

(52) U.S. Cl. 358/487; 358/506

(57) ABSTRACT

An imaging system which can scan and capture high-quality digital images at high speeds, including the ability to adjust the exposure setting of the digital camera to accommodate the variable film exposure experienced with consumer film. According to a preferred embodiment of the invention, this is achieved through the use of a pre-scan function which determines film density and permits the exposure settings of a line-scan camera to be adjusted on a frame by frame basis during a frame gap in response to the predetermined density for each frame.

### CROSS REFERENCE TO RELATED APPLICATIONS

This application claims priority from provisional patent Application Ser. No. 60/543,646, filed on Feb. 11, 2004, the entire contents of which are expressly incorporated herein.

### FIELD OF THE INVENTION

The present invention relates generally to the field of photography, and in particular to the scanning of photographic film to produce digital images.

### BACKGROUND OF THE INVENTION

Photographic film is photographic material consisting of a base of celluloid covered with a photographic emulsion; used to make negatives or transparencies. This includes consumer photographic film as well as professional film, microfilm, motion picture film, and other types of film used to capture images. Photographic film can be scanned to produce a digital image. This is generally accomplished by passing light through the film and onto an image capture device such as a CCD sensor in a digital camera. A number of consumer systems are available, such as the Nikon Coolscan and Minolta Dimage Scan film scanners. Such systems are rather slow and only suitable when scanning a low volume of photographic film, or when the speed of scanning is not important.

For high-speed scanning, systems such as the Walde FilmStar 15K scanner, the Kodak I-LAB scanner, or the CYRA line of scanners are often used. In such systems, rolls of consumer film are spliced together to produce a continuous reel of film. These reels are mounted on the scanner and scanned together to produce a set of digital images for each roll of film.

At large photographic film processing labs such as those owned by Eastman Kodak and District Photo, photographs are typically produced directly from photographic film negatives rather than through the use of digital images. One reason for this is that current film scanner systems cannot obtain both the quality and speeds obtained by the high-speed optical printers used in most labs, which often exceed 18,000 photographs, or frames, per hour. In addition, these optical printers have so far shown more flexibility in dealing with the wide range of film exposures taken by consumer photographers.

It is desirable, therefore, to provide a system that could scan digital film at the same rate obtained by high-speed optical printers, and that could provide a means to achieve the same image quality for very under or very over exposed images often seen in film processing labs.

### SUMMARY OF THE INVENTION

In accordance with one aspect of the invention, therefore, a film transport mechanism is provided that can exceed 18,000 frames per hour. The film transport includes an adjustable drum gate to stabilize the film for scanning with a line scan camera.

In accordance with another aspect of the invention, an imaging system is provided that can capture high-quality digital images at speeds exceeding 18,000 frames per hour, including the ability to adjust the exposure setting of the digital camera to accommodate the variable film exposure experienced with consumer film.

In yet another aspect of the invention, a means to provide continuous scanning of multiple reels of film is provided, allowing high-speed scanning to occur continuously over an extended period of time.

These and other advantages and objects of the present invention will be apparent to those skilled in the art in connection with the following discussion and the attached figures.

### BRIEF DESCRIPTION OF THE DRAWINGS

FIG. 1 is a schematic diagram of the high-speed scanner of the present invention particularly illustrating the path of photographic film through the film scanning system;

FIG. 2 is a schematic diagram of the high-speed scanner of the present invention particularly illustrating the path of photographic film through the film scanning system and also showing the location of the camera cover portions in a preferred embodiment;

FIG. 3 is a schematic diagram of the power and light handling components of the high-speed scanning system of the present invention, in a preferred embodiment thereof;

FIG. 4 is an exemplary screen shot from the scanning system control program of the present invention in a preferred embodiment; and

FIG. 5 is a drawing illustrating the autosplice—de-splice feature of the present invention in one embodiment thereof.

### DETAILED DESCRIPTION OF THE PREFERRED EMBODIMENTS

In its broadest aspect, the invention comprises the system and method for performing the complete function of scanning a series of photographic film images to generate high-quality digital image files.

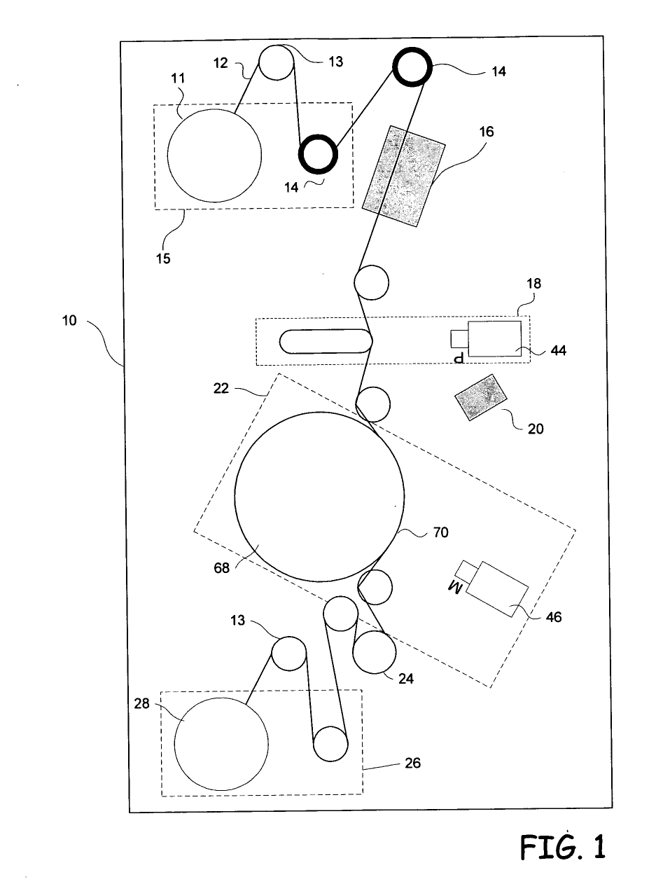

As shown in FIG. 1, the film scanning system 10 includes a supply reel 11 that feeds photographic film 12 through one or more film rollers 13 and particle transfer rollers, or PTR rollers 14, and a supply bail-arm assembly 15. The supply reel 11 can vary in size and for different film formats as is well known in the art. The film rollers 13 transport the film through the system without contacting the imaging area of the film. Such rollers are recessed so that only the edges of the roller contact the photographic film 12, and can be dually recessed to accommodate different film sizes. The PTR rollers 14 are de-ionizing and anti-static rollers that contact both sides of the film to assist in cleaning the film surface. Standard film and PTR rollers are well known in the art, and are not discussed further herein. The film rollers 13 can preferably handle film sizes from 8 mm to 70 mm, and may be replaceable as required to achieve a proper film path for different film sizes.

The supply bail arm assembly 15 maintains tension on the film by establishing a closed system with a bail arm and the supply reel 11. Once again such systems are well known in the art.

Continuing in FIG. 1, the film passes through a film cleaner 16. Such a cleaner is not required, but helps to ensure that any dust and other particles on the film are removed prior to passing through the imaging systems.

From the film cleaner 16, the film passes through a pre-scanner imaging system 18, past a barcode reader 20, and through a main imaging system 22. The pre-scanner imaging system 18 performs preliminary analysis on the film image, as further discussed herein. The barcode reader 20 optionally reads an opaque bar code, or twincheck number, attached to the film. The main imaging system 22 uses the data captured by the pre-scanner imaging system 18 to capture a high-resolution digital image from each film frame. The details of the main imaging system 22 will be discussed further herein.

Continuing with FIG. 1, the film leaves the main imaging system 22 and passes through a drive motor 24, additional film roller 13, a take-up bail arm assembly 26, and finally onto a take-up reel 28. These aspects of film scanning systems are well known in the art, and will not be discussed further herein. It will be appreciated that the exact location and type of these and other parts in the system can vary, without altering the key aspects of the invention.

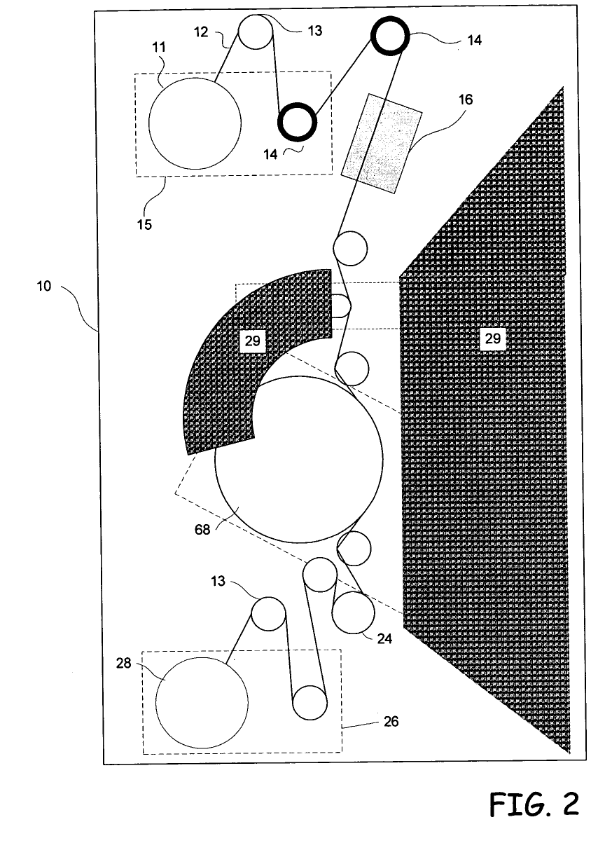

It should be noted that, as with any digital film scanner, the presence of external light affects the quality of any captured digital images. It is therefore desirable to shield the light sources and imaging systems from such light, to maintain the quality of any generated images. FIG. 2 illustrates possible locations of camera covers 29, in a preferred embodiment, to reduce the effect of external light. It will be appreciated that proper placement of the system within a given setting is critical to ensure that an undue amount of external light is not present. Such restrictions on the environmental setting of a scanning system are common in the art, and include the temperature variance, power variance, and other environment factors in addition to the amount and type of ambient light.

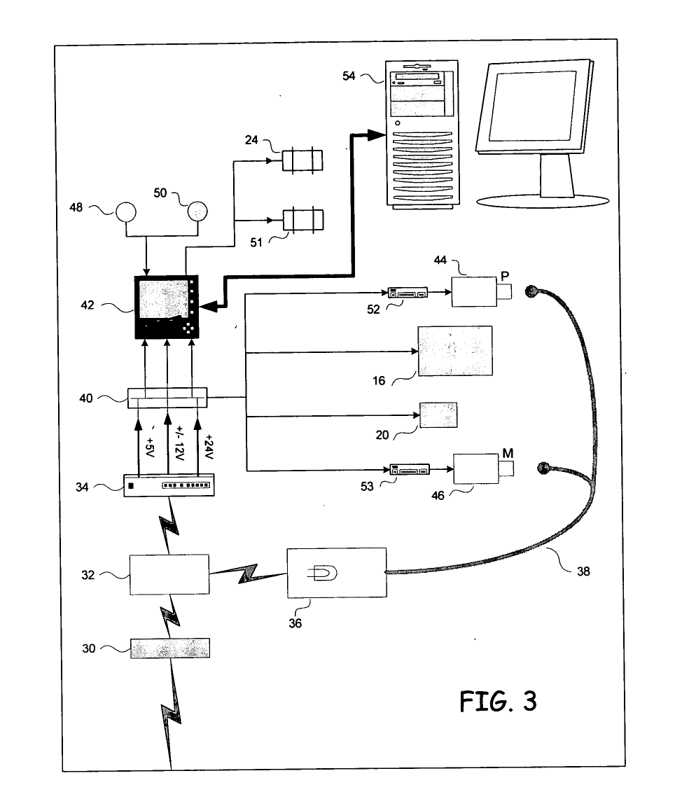

Turning now to FIG. 3, a schematic of the power and light handling components of system 10 is presented. A regular wall outlet may be used to power the system, such as the 120V AC power available in the United States. The power enters the system through a circuit breaker 30 and into a terminal block 32. The circuit breaker 30 protects the system from unexpected power surges. The terminal block 32 splits the power and provides it to the main power supply 34 and the lamp/power supply 36. The lamp power supply 36 receives AC voltage in and powers a DC lamp 36 to provide light to the system. In a preferred embodiment, a Schott Fostec DCR III power supply provides 21V DC power to a Uschio EKE 150W light bulb in a preferred embodiment. Alternatively, a General Electric ELC 250W light bulb may also be used, for example. A fiber optic light pipe 38 receives the light from the lamp 36 and splits it between the two required light sources in the system.

One option for the fiber optic light pipe 38 is a standard light pipe that sends half of the light to the pre-scanner system and the other half to the main system. An advantage of this is that such light pipes are readily available from commercial suppliers, such as the Dual Light Line available from Schott Fostec. As discussed herein, the pre-scanner system generates a lower resolution image than the main system, and therefore can handle a lower level of light. The main imaging system 22 produces a higher-quality and high-resolution image, and therefore requires a bright light source to generate the best quality image. For this reason, the fiber optic light pipe 38 is preferably customized to send a larger portion of the light to the main system. The recommended amount of light for the main system is two-thirds of the total light, although alternate amounts may also be appropriate depending on the exact camera and lighting components used to build the system.

The fiber optic light pipe 38 may include a cylindrical lens to focus the light into a line at the end of the pipe for the pre-scan portion. It is also possible to include a cylindrical lens for the end of the pipe for the main scan portion as well as long as enough light can ultimately be delivered for the main scan. The focused line of light is preferably 2 inches long for the preferred components, but alternate lengths may be appropriate depending on the actual film size to scan.

Returning to FIG. 3, the main scanner power supply 34 receives AC voltage in and converts it to DC out. The preferred outputs from this power supply are +5V, +/−12V, and +24V. A power supply from Integrated Power Designs is preferably used for this purpose, model CE-225-4101. The DC power is sent to a power distribution board 40 to distribute these voltages to other parts of the system. One such board is available from Walde, Inc. or alternatively from Bremson, Inc.

The power distribution board 40 sends all output voltages to the Walde FilmStar board 42, as well as +12V to the prescan camera 44, +12V to the film cleaner 16, +5V to the barcode reader 20, and +24V to the main camera 46. The exact voltage required by each piece of hardware may vary depending on the exact model used.

The Walde FilmStar board 42 is a custom board built for the Walde FilmStar 15K scanner or the Walde FilmStar 20K Pro scanner. This board receives input from an encoder 48 and potentiometers 50. These inputs are used to drive the film reel motors 51 in the take up and supply bail arm assemblies as well as the drive motor 24 using pulse-width modulated (PWM) power. Pulse width modulation is a well-known power supply mechanism to supply a non-constant voltage to a device. In addition to PWM power, the Walde FilmStar board 42, in one embodiment can also generate a camera trigger to control the cameras in the two imaging systems. Alternatively, and in a preferred embodiment, operation may be in “free-run” mode as opposed to using a trigger.

The encoder 48 determines encoder counts based on the spin of the drive shaft. This ensures that encoder counts are only created when the film is moving as a result of the drive motor 24. An encoder of this type is available from Danaher Controls, part number F188192/0335B. This type of encoder enables smooth and constant velocity transportation of the film. When in “trigger” mode as opposed to “free-run” mode, these encoder counts can generate the trigger in the Walde FilmStar board 42, which is sent to a pre-scanner digitizing card 52 and a main camera board 53. The pre-scanner and main cameras may be triggered based on these encoder triggers. If a “trigger mode” is used, the Walde FilmStar board 42 sends a camera trigger every 4 encoder counts from the Danaher motor; the pre-scanner digitizing card 52 triggers the pre-scanner camera 44 every 16 camera triggers, which is every 64 encoder counts; and the main camera board 53 triggers the main camera 46 every 2 camera triggers, which is every 8 encoder counts.

The potentiometers 50 monitor the position of the bail arms in the supply and take up bail-arm assemblies 15 and 26. When the film is in motion, the potentiometers 50, or pots, report a value from 0 to 5V. The Walde FilmStar board 42 uses the pots values to drive the film reel motors 51 for the supply and take up reels 11 and 28 to keep the bail arms centered and the proper film tension applied during scanning. Such techniques should be familiar to those well versed in the art.

The Walde FilmStar board 42 also includes an RS-232 serial port for communication with a host computer 54. The host computer 54 is a standard PC that controls the scanning system and analyzes and records digital image data. The preferred model is an NCS Reliance III Model CQ1-S205 configured with an Intel Xenon 3.2 GHz dual server CPU with 1 MB L2 cache, 1 GB SDRAM, and four IBM/Hitachi Deskstar 180 GB disk drives that are plugged into a RAID controller card. The four physical disk drives are preferably striped to create a single logical disk in a manner well known in the art to obtain the highest possible disk performance when reading and writing data.

The host computer 54 also includes digitizing boards for. capturing image data from the two imaging cameras. The selected boards should be chosen to interface with the selected imaging cameras.

FIG. 1 shows additional details of the pre-scan and main subsystems described for the scanning system 10. The pre-scanner imaging system 18 passes light from the fiber optic light pipe 38 through the photographic film 12 and into a pre-scan camera 44. The pre-scan camera 44 assembles a digital image of each film frame and performs preliminary analysis on the frame. Preferably, a Dalsa Spark SP-14-01K30 camera, which is a 1024 pixel line scan camera, is used for the pre-scan camera 44, with a LVDS cable that sends 8-bit imaging data to a Bitflow Roadrunner R12 board in the host computer 54 to digitize the pre-scanner data into a digital image stream. This board provides an SDK that is used by the pre-scanner software to obtain the digitized data. The exact size of digital images from the pre-scan camera varies depending on the film format and exact pre-scanner calculations. In a preferred embodiment, 384 lines of data are collected for each frame. For standard 35 mm film, which has a 2:3 aspect ratio, the Dalsa camera produces a continuous 8-bit gray-scale image of the film, with 1024 pixels by 384 lines worth of data captured for each frame. The pre-scanner software on the host computer 54 down-samples this data to produce a 256 by 384 bit image for each frame.

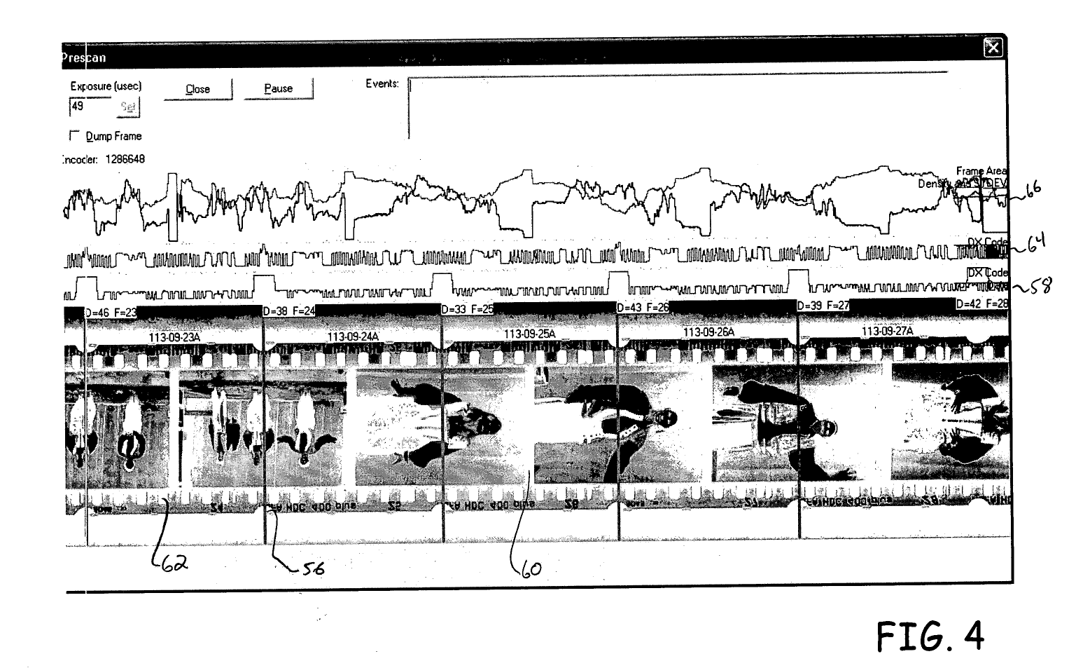

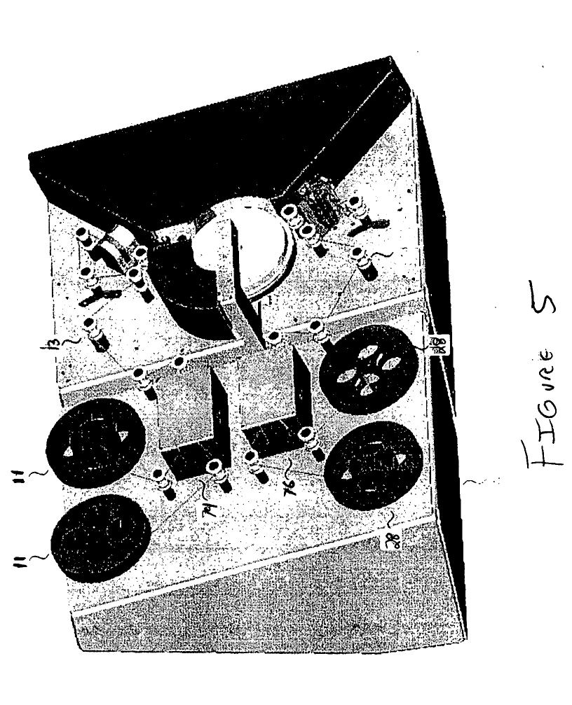

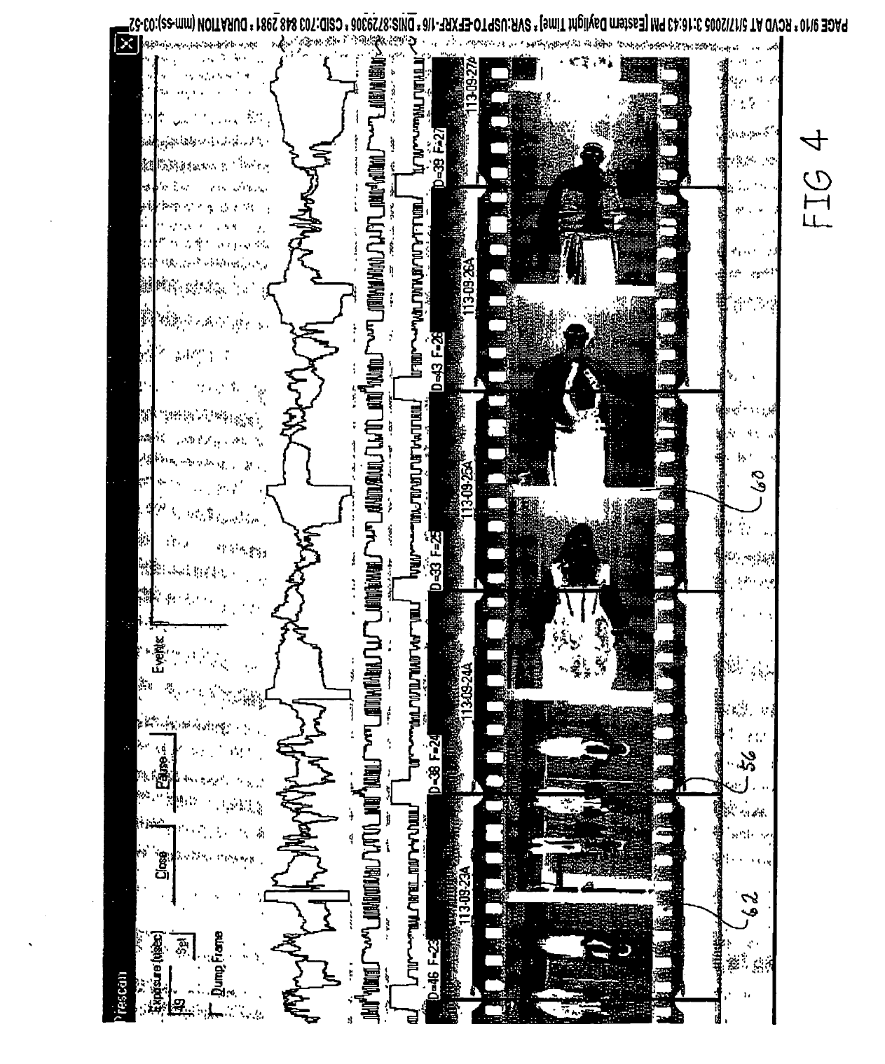

The analysis performed by the pre-scan camera 44 determines the film format, the starting location of each roll of film, the specific location of each frame, and the DX or other codes on the film. This is illustrated in FIG. 4, which is a screenshot from the novel control system of the present invention and wherein a continuous photographic film image of 35 mm film is shown along with analysis data from a pre-scanner imaging system. In FIG. 4, the film format is determined by the width of the film and the frame within the film. This can distinguish between APS film, which is 24 mm wide; regular 35 mm film, such as that shown in FIG. 4; and full frame 35 mm film, where no sprockets are used and the frame encompasses the majority of the width of the film. Other formats, such as 46 mm or 70 mm, are determined in a similar manner.

The start of each roll of film, which is not shown in FIG. 4, is determined by detecting an opaque region of film where two rolls of film are spliced together. In most photographic processing labs, the splice contains a barcode that is used to identify the subsequent roll. Alternately, a splice without a bar code can be used and the rolls can be numbered sequentially or identified by other information located on or near each frame. For example, APS film contains a film identifier, or fid, for this purpose. The barcode reader 20 reads the bar code value off the opaque splice, while film values such as the APS fid are identified by the pre-scanner imaging system.

The location of each frame can be determined one of various possible techniques, including notch detection, frame gaps, and sprocket hole detection. Consumer film is typically notched in the center of each frame, allowing a notch detection algorithm to detect each film notch 56. FIG. 4 displays the first results output 58 of such a detection algorithm that locates these notches 56 by looking for blank spaces along the edge of the film.

An alternate means to locate each frame is to detect the frame gaps 60 between each frame. This technique can be used with un-notched 35 mm film or with professional formats where notching is not typically performed. Except in highly over exposed film or very dark images, these gaps are located by detecting the light space between each frame. In film where the gap is not immediately detected, the gap location can be inferred based on the location of other gaps and on the expected frame size for the current film format.

Yet another means to locate each frame of the photographic film 12 is by counting the sprocket holes 62 on the edge of the frames. This technique is appropriate when scanning movie film to determine the frame locations, since movie frames are evenly spaced along the film.

The pre-scanner imaging system 18 determines the DX or other barcode values included on the film by tracking the density of a predetermined area of the film. FIG. 4 shows the results of such tracking as part of the first results output 58 and second results output 64. In the figure, the output tracks the two portions of the 35 mm DX barcode to determine the film manufacturer, the film type, and the frame number. The format and decoding of DX codes are well known in the art, and will not be discussed herein. Other bar code values, such as the APS fid number or the proprietary barcode and punch values used by some professional labs can be determined in a similar manner.

The final value determined by the pre-scanner imaging system 18 is an estimate of the overall film density of each frame. The third results output 66 in FIG. 4 shows some preliminary density analysis of each frame, with the minimum and maximum density values plotted on a graph. The overall average density of each frame is assigned using techniques well known in the art, and can be calculated using the luminance values of the image in addition to or instead of the minimum and maximum density values.

The result of the film density analysis is an overall film density value for a frame between 0 and 255. This value is then used to categorize the film within an overall exposure category. An exposure of 0 is a normal exposure, and might relate to a film density of around 128. An under exposed image will have a high density value of perhaps 200 or more, and will be assigned a negative exposure. An over exposed image will have a low density value of perhaps 10, and will be assigned a positive exposure.

There are a number of techniques for establishing and assigning exposure categories. The preferred method involves categorizing film on a curve where the −3, −2, −1, +1, +3, and +5 exposures are plotted for the corresponding film type. The image is then categorized based on which section of the curve it falls into, yielding a set of seven possible exposure categories. Note that the normal exposure of 0 is excluded, since the film curve is essentially linear between the slightly under and over exposed settings of −1 and +1.

The preferred method for determining a film's curve is to track historical film data for each film type. The average film density of a large number of images is treated as the normal exposure setting, with other exposures assigned based on the historical data. Preferably, the system is pre-calibrated with a set of known film types to establish the initial relationship between density and exposure. One or more calibrated reference negatives are required for each film type, such as the True Balance negatives available from Aperion, Inc. A reasonable sampling of the varieties of film types is preferred. For 35 mm film a set of 15 to 20 film types is preferred, while for APS film a set of three to five film types is preferred.

Once the initial calibration is performed, the system can automatically build a historical record of the actual density values seen in production film. These values are used to constantly update the film curve for each film type, such that the location of each exposure category changes in real time based on the captured data. The building of film curves from a set of density values is a common technique in the art, and is not explained in detail herein.

When a new film type is detected by the system, based on a DX or other code on the film that is not recognized, the scanning system must have a way to assign exposure categories to the new film type. One way to do this is to require an operator to re-calibrate the initial values for each new film type. A preferred method is for the scanning system to perform whole roll analysis to establish the initial values for the new film type.

In whole roll analysis, the scanning system scans the entire roll to generate as much density information as possible for the new film type. This density information is used to establish an initial film curve for the new film type, which is then compared to the film curves currently available. The best match from the existing set of known curves is found, and the characteristics of the film type for this matched film curve are used as the initial settings for the new film type. Note that the photographic film 12 must be rewound after performing whole roll analysis in order to obtain the main scan of the each frame.

Once the initial values for a new film type are established, the system will start building a historical record for the new type, so that over time a more accurate representation for the film type is repeatedly established. This whole roll analysis is repeated each time the new film type is encountered until a large enough sampling of frame data is established so that the calculated film curve is stable. The number of images required for a film type depends on the exact properties of the film. Preferably, the system monitors the stability of the film curve generated for new film types until the curve is deemed to be stable.

Returning now to FIG. 1, the main imaging system 22 is shown. In the figure, the photographic film 12 travels between two film rollers 13 and over a drum gate 68. The film rollers 13 before and after the drum gate 68 are positioned close to the film path over the drum in order to guide the film onto and off of the drum.

The drum gate 68 can be adjusted to accommodate varying widths of film, and provides additional tension for the film as it passes in front of the main camera 46. Note that the width of each side of the drum gate 68 should be wide enough to handle the edge of film being scanned, and yet thin enough to not interfere with the main scan of each film frame. The adjustment of the drum can be handled through an electronic mechanism or with a manually adjusted mechanism that locks the drum into alternate positions. The tension provided by the drum gate is achieved naturally due to the curve of the drum and by the spring tension in the bail arm assemblies, and also ensures that the film is stable and locked onto to drum as the main camera 46 scans each image.

In a preferred embodiment, the light source is located inside the drum and a transmissive scan (as opposed to a reflective scan) is performed. It is quite common in the art to use a drum for scanning but typically, the light source is located outside of the drum. According to the present invention in a preferred embodiment the light source is on the inside of the drum and the drum is very large which enables accommodation for the space for the light source as well as providing for a high degree of inertial dampening of external vibration sources which could affect the sharpness and overall quality of the image while it is scanned by the main camera 46.

The main scan location 70 of the main imaging scan is an important consideration. The halfway point of the film path around the drum is an optimal spot for stability of the film, but it is important to leave enough space between the pre-scanner imaging system 18 and the main scan location 70 for the main imaging scan. This space allows the pre-scanner system to ensure it has properly identified the type of film and location of each frame in cases where the film may contain marks or exposed areas that interfere with the algorithms used to determine such information. For this reason, the main scan, which is undertaken shortly after the center point on the drum, is preferred to ensure that the pre-scanner has completed analysis of enough frames to ensure an accurate identification of both the film type and the frame location.

To achieve the desired speed of over 18,000 images per hour, the main camera 46 must be able to capture at least 5 frames per second. Each frame, therefore, must be captured in 200 milliseconds. To capture a high resolution 2K by 3K image, sometimes referred to as a 16 base (6 MegaPixel) image in the art, it is assumed that a line scan camera would capture a 2K line of pixels with each scan. In order to achieve this, the camera would have to capture 3000 2K lines, or one full frame, in 200 milliseconds, or one line per 66 microseconds. A preferred model for the main camera 46 is the Atmel Akyla 40 camera. This camera contains a trilinear CCD to capture the true color of each pixel in the image, and can achieve 18700 lines per second at 12 bits per pixel. The camera also provides individual control of each RGB color's exposure time. The digital data is preferably transferred over two camera link connectors to send 36 bits of data for each pixel. The camera link connectors send the data to a Bitflow RoadRunner R64 board, where the data is digitized and made available to the host computer via an SDK provided by Bitflow.

While a good scan of each image can be obtained with a fixed exposure time, the use of a variable exposure time is preferred because a different amount of light is required to achieve the optimum scan of each film frame. This fact is well known in the art, but line scanning systems typically provide a constant light source and a fixed camera exposure setting. An image analysis is then performed to reduce the image data captured to an 8-bit RGB image. This technique works extremely well for a fixed film exposure value, typically a slightly over exposed value of +1 for consumer 35 mm film, and also works well for exposure values near this fixed value. Because of the fixed exposure setting, however, data collected for very under and very over exposed images is not optimal for producing an ideal digital representation of the original film frame.

A fixed light source with a variable camera exposure time can overcome this problem by adjusting the camera exposure time for each frame. This permits the optimum exposure value to be used for each frame, rather than selecting a common exposure time that is applied to all frames. The use of variable exposure times has been used successfully in area-array scanning system such as the FilmStar 15K scanner from Walde Inc, which uses a constant light source with variable exposure settings. An area-area scanning system freezes the film and collects all data for an entire frame in one camera image.

Line scan systems keep the film moving at a constant speed both to achieve high scanning rates and because the image data is captured a line at a time as opposed to a frame at a time. For this reason, variable exposure times have not heretofore been used in line scanning systems. Variable exposures times can be achieved in a line scanning system by changing the exposure timing between frames, while the frame gap passes in front of the camera.

The current invention employs this technique by reprogramming the exposure time of each color in the camera based on the information from the pre-scanner density values. This reprogramming takes place during the frame gap when no image data is captured, which at 5 to 6 frames per second yields a gap of approximately 5 to 7 milliseconds for consumer 35 mm film. This allows all lines captured for a frame to be obtained using an optimum exposure time for that frame. This ensures that an optimum range of digital data is collected for each frame, including very under and very over exposed frames.

While the framegrabber board from Bitflow (the RoadRunner R64 board) allows for the reprogramming of the Red, Green, and Blue exposure times of the main camera 46, difficulties can arise in attempting to send the proper sequence of commands (using the SDK provided by Bitflow) to complete the exposure settings during this short 5 to 7 millisecond passing of the frame gap. Because of inherent latency in the Windows XP operating system and the fact that the time it would take to set the exposure times would vary, there are potential issues with maintaining proper frame registration when attempting to reprogram the exposure times during the passing of the gap. These issues were addressed as a result of a discovery that the reason for the variance in the time it took to program the exposure times was related to the actual difference in the new exposure time and the old exposure times for each of the red, green, and blue channels. When the change in exposure times was very small (i.e. the pre-scan densities were very similar on previous frame to current frame), then the time it took to change exposure times was very small, or about 200 microseconds. When the change in exposure times was very large (i.e. the pre-scan densities were very different on previous frame to current frame), then the time it took to change exposure times was very large, or up to about 1000 microseconds.

The novel solution implemented in accordance with the preferred embodiment of the present invention is to always employ a fixed delay equal to the maximum time it could ever take to change exposure times, which corresponds to about 1000 microseconds on the selected system PC. Once this fixed delay is used, the frame registration issues were resolved and the desired goal of changing exposure times for each frame during the passing of the frame gap could be achieved.

It will be appreciated that an alternate method for achieving fast scanning can be obtained with fixed exposure times in the camera, but with a variable light source. This technique is employed in the PictureVision 4B-100 system from PictureVision, Inc. The 4B-100 is an area array scanning system that employs a fixed exposure time with variable RGB light sources. A drawback of this approach for line scanning systems as with the present invention is that it typically takes a period of time for a modified light source to settle into a constant light supply, which may present problems in the short time span that the frame gap moves in front of the light source. Another difficulty is that the optimum amount of light might be different for each color, which could required a separate imaging system for each color value to achieve the equivalent data obtained using the preferred approach.

The host computer 54 receives and processes digital data from the imaging systems. In the preferred embodiment, there is one main program to control the film transport, pre-scan of the photographic film 12, and the main imaging of the film. The control and pre-scan components of the program interact with the Walde FilmStar board 42 and the Bitflow board to receive the pre-scan data and perform pre-scan analysis of the data.

The main imaging component of the program uses the pre-scan data to set the exposure values for each color in the main camera 46, and receives imaging data from the main camera's Bitflow board. The main imaging data for each frame is converted into a target digital image format using digital color management techniques well known in the art. The exact digital image format can vary depending on the specific use required for the resulting images. In the preferred embodiment, the main image data is converted into a 24-bit color bitmap image, and then saved to disk as a compressed JPEG file. The main imaging component of the program also maintains the historical data for each film type and calculates exposure values for each frame based on this data.

It will be appreciated that additional digital image manipulations may be performed on the digital data prior to, during, or after the main camera data is converted to a standard RGB image. Such manipulations are easily applied by a person of ordinary skill in the art and are not discussed herein. It will also be appreciated that, for some environments, the original main imaging data for each frame may be desired and saved directly to disk for later processing. Alternately, an uncompressed bitmap image or alternate format other than JPEG, such as EXIF, PDF, or the Pegasus PIC format, may be required. The creation and storage of such formats are well known in the art and not discussed further herein.

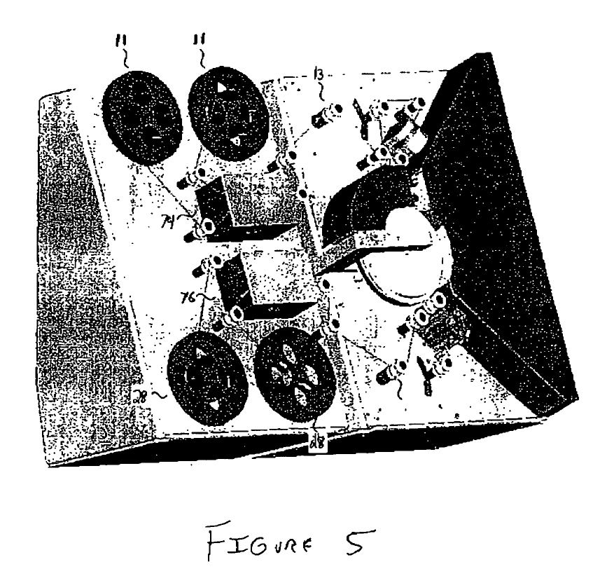

In an extension of the current invention, it will be appreciated that when scanning the photographic film 12 at high-rates of speed, the time it takes for an operator to load and unload a reel can have a serious impact on the overall throughput of the system. FIG. 5 shows an auto-splice de-splice system 72 (ASDS) that can increase the throughput of the system by performing continuous scanning of multiple reels of film.

As can be seen in FIG. 5, the film scanning system 10 and in particular, the ASDS 72 is loaded with two supply reels 11 and two take up reels 28. The supply reels 11 feed into an auto-splice box 74 that joins the end of the first supply reel with the start of the second supply reel. Upon exiting the film scanning system 10, the film enters a de-splice box 76 that de-splices the film to recreate the original two reels. Each reel is sent to a different take-up reel 28.

By replacing completed supply reels with new reels, and replacing full take-up reels with empty reels, an operator can ensure that the film scanning system 10 continuously scans reels of film over an extended period of time. This ensures that the film scanning system 10 can operate continuously and keep up with high-speed output devices such as printers or other image processing equipment.

The invention has been described herein with reference to a preferred embodiment. It will be appreciated that a person of ordinary skill in the art can affect variations and modifications without departing from the scope of the invention. Although disclosed with respect to the scanning of particularly film types such as 35 mm stills, and motion picture film, this invention and its applicability is not necessarily limited thereto. The disclosure contained herein is not intended to be exhaustive or to limit the invention to the precise forms disclosed. The scope of the invention is to be defined only by the claims, and by their equivalents.

1. A scanning system for digitizing images contained upon film comprising:
(a) a film transport mechanism for advancing said film;
(b) means for pre-scanning said film in order to determine a density value for said film; and
(c) means for scanning said film following the pre-scan of said film wherein the exposure of said scan is adjusted with respect to said determined density value for said film.

2. The scanning system of claim 1 wherein said means for scanning said film scans said film on a line by line basis.

3. The scanning system of claim 1 wherein said film comprises a plurality of frames and said means for pre-scanning determines a density value for each of said frames contained on said film.

4. The scanning system of claim 3 wherein said means for scanning said film adjusts the exposure of the scan for each of said frames individually and wherein said adjustment occurs during the time period when a frame gap between two frames passes through said means for scanning said film.

5. The scanning system of claim 1 further comprising at least one cover portion for reducing the effect of external light during the scanning process.

6. The scanning system of claim 1 further comprising a fiber optic light pipe for supplying light to each of said means for pre-scanning and said means for scanning.

7. The scanning system of claim 1 wherein said means for pre-scanning and said means for scanning operate in a triggered mode.

8. The scanning system of claim 1 wherein said means for pre-scanning and said means for scanning operate in a free-run mode.

9. A variable exposure line scanner for high-speed scanning of film comprising:
(a) a transport mechanism for advancing said film;
(b) a pre-scan camera, said pre-scan camera determining a film density value for each of a plurality of frames contained on said film;
(c) a main scan camera, said main scan camera adjusting exposure values for each of said frames contained on said film in response to the film density value for each said frame; and
(d) a system controller for controlling said pre-scan camera, said main scan camera, said transport mechanism and at least one device for storing scanned images.

10. The variable exposure line scanner of claim 9 wherein said storage device for storing scanned images comprises a plurality of physical disk drives.

11. The variable exposure line scanner of claim 9 wherein said pre-scan camera further identifies at least one code contained on said film.

12. The variable exposure line scanner of claim 9 further comprising a bar code reader for reading bar codes positioned on said film.

13. The variable exposure line scanner of claim 9 further comprising a light source and a light pipe for distributing said light from said light source to said pre-scan camera and said main scan camera.

14. The variable exposure line scanner of claim 13 wherein more light is distributed to said main scan camera than to said pre-scan camera.

15. The variable exposure line scanner of claim 9 wherein said system controller further comprises means for identifying when a new frame is to be scanned.

16. The variable exposure line scanner of claim 9 wherein said system controller further comprises means for tracking historical film density data for a plurality of film types.

17. The variable exposure line scanner of claim 9 wherein the exposure settings of said main scan camera are adjusted by said system controller during the time that a frame gap passes through said main scan camera.

18. A method for scanning and digitizing film, said film containing a plurality of frames, said method comprising the steps of:
(a) passing a frame of said film through a pre-scan module, said pre-scan module determining a film density value for said frame;
(b) adjusting the exposure settings of a main-scan module in response to said film density value for said frame; and
(c) passing said frame through said main-scan module and capturing an image representative of said frame.

19. The method of claim 18 wherein said step of adjusting the exposure settings occurs during the time that an inter-frame gap between two frames passes through said main-scan module.

20. The method of claim 18 wherein said step of capturing an image comprises a line scan for said frame.
